(19) United States
(12) Patent Application Publication
(10) Pub. No.: US 2026/0167216 A1
(43) Pub. Date: Jun. 18, 2026

(54) METHOD OF CONTROLLING A FORWARD COLLISION-AVOIDANCE ASSIST (FCA) WARNING OF A VEHICLE, AN AUTONOMOUS VEHICLE, A PROGRAM, AND A COMPUTER-READABLE RECORDING MEDIUM

(71) Applicants: HYUNDAI MOTOR COMPANY, Seoul (KR); KIA CORPORATION, Seoul (KR)

(72) Inventor: Dong Ju Lee, Hwaseong-si (KR)

(73) Assignees: HYUNDAI MOTOR COMPANY, Seoul (KR); KIA CORPORATION, Seoul (KR)

(21) Appl. No.: 19/321,919

(22) Filed: Sep. 8, 2025

(30) Foreign Application Priority Data
Dec. 13, 2024 (KR) 10-2024-0186223

(51) Int. Cl. B60W 50/16; B60W 30/095; B60W 50/14

(52) U.S. Cl. CPC B60W 50/16; B60W 30/0956; B60W 2050/143; B60W 2050/146; B60W 2420/403; B60W 2420/408; B60W 2554/404; B60W 2555/60

(57) ABSTRACT

A method of controlling a forward collision-avoidance assist (FCA) warning of a vehicle includes checking a motion of a forward vehicle by a sensor, determining the forward vehicle is at risk of collision with an ego vehicle based on the motion of the forward vehicle, determining whether the forward vehicle satisfies a requirement for FCA warning generation suppression, and suppressing generation of the FCA warning based on the forward vehicle satisfying the requirement for FCA warning generation suppression.

### CROSS-REFERENCE TO RELATED APPLICATIONS

This application claims the benefit of priority to Korean Patent Application No. 10-2024-0186223, filed on Dec. 13, 2024, which is hereby incorporated by reference as if fully set forth herein.

### BACKGROUND OF THE DISCLOSURE

### Field of the Disclosure

The present disclosure relates to a method of controlling a forward collision-avoidance assist (FCA) warning of a vehicle, an autonomous vehicle, a program, and a computer-readable recording medium. More particularly, the present disclosure relates to a method of controlling an FCA warning, an autonomous vehicle, a program, and a computer-readable recording medium that control an FCA warning for preventing collision with a forward vehicle in front of the (e.g., subject) vehicle to prevent unnecessary braking of the (e.g., subject) vehicle or discomfort to a driver or a passenger.

### Discussion of the Related Art

Autonomous driving systems have been applied to or included in recently released vehicles to provide safety for reducing traffic accidents, improved traffic efficiency on a road, environmental friendliness by fuel savings, convenience, and the like.

An autonomous driving system, as recently included in vehicles, is technology that uses cameras to recognize lanes and perform automatic steering, and measures a lane width, a lateral position of a vehicle in a lane, distances to both lanes, a shape of the lane, and a radius of curvature of the road based on image processing of the cameras. In addition, a smart cruise control (SCC) function is provided to estimate a driving trajectory of the vehicle using the measured position of the vehicle and road information, and to change lanes according to the estimated driving trajectory.

Programs and devices for a Forward Collision-Avoidance Assist (FCA) function are installed in an autonomous vehicle having the above-mentioned SCC function. The FCA function is a function for distinguishing a forward vehicle ahead or in front of the ego vehicle, traveling in the same direction as the ego vehicle, for example, as determined from objects detected ahead or in front of the ego vehicle, and warning a driver or autonomously braking the vehicle. As used herein, an “ego vehicle” may refer to a vehicle being controlled by the subject autonomous driving system.

However, even when a forward vehicle is detected in front of an ego vehicle, there is no need to generate an FCA collision warning when the forward vehicle decelerates to turn left/right, change lanes, etc., and leaves or is no longer in front of the vehicle, since there is no risk of collision with the vehicle ahead. However, an FCA system of the ego vehicle does not consider a driving direction of the vehicle ahead, and thus generates an unnecessary FCA collision warning, which may cause inconvenience to the driver and passenger(s).

### SUMMARY OF THE DISCLOSURE

Accordingly, the present disclosure is directed to a method of controlling a Forward Collision-Avoidance Assist (FCA) warning of a vehicle, an autonomous vehicle, a program, and a computer-readable recording medium that substantially obviate one or more problems due to limitations and disadvantages of the related art.

The present disclosure is intended to solve the above-mentioned problem. An object of the present disclosure is to provide a method of controlling an FCA warning of a vehicle and an autonomous vehicle which does not generate an FCA warning even when a forward vehicle is detected in front of an ego vehicle, if the forward vehicle is expected to soon depart from the front of the ego vehicle by changing lanes, etc.

Additional advantages, objects, and features of the disclosure will be set forth in part in the description which follows and in part should become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, a method of controlling a forward collision-avoidance assist (FCA) warning of a vehicle is provided. The method includes: checking a motion of a forward vehicle by a sensor; determining the forward vehicle is at risk of collision with the ego vehicle based on the motion of the forward vehicle; determining whether the forward vehicle satisfies a requirement for FCA warning generation suppression; and suppressing generation of the FCA warning based on the forward vehicle satisfying the requirement for FCA warning generation suppression.

Based on the forward vehicle not satisfying the requirement for FCA warning generation suppression, the FCA warning may be generated using at least one of a visual, an auditory, or a tactile method.

The method may further include determining whether the forward vehicle satisfies a requirement for FCA warning generation suppression release, wherein the FCA warning is generated using at least one of a visual, an auditory, or a tactile method when the forward vehicle satisfies the requirement for FCA warning generation suppression release.

Based on the forward vehicle not satisfying the requirement for FCA warning generation suppression release, the suppressing generation of the FCA warning may be continued.

The determining whether the forward vehicle satisfies a requirement for FCA warning generation suppression may include a step (a) of determining whether there is change in a number of tires of the forward vehicle detected by the sensor, a step (b) of determining whether a number of turned-on turn signals in the forward vehicle changes from one to two, and a step (c) of determining whether a lateral width of the forward vehicle increases, wherein, when at least one of the steps (a)-(c) is determined to be YES, the forward vehicle is determined to satisfy the requirement for FCA warning generation suppression.

Based on all the steps (a)-(c) being determined to be NO, the FCA warning may be generated using at least one of a visual, an auditory, or a tactile method.

The step (a) may include recognizing the number of tires and determining whether there is change in the recognized number of tires when the forward vehicle travels in the same lane as a lane of the ego vehicle.

The step (b) may include recognizing the number of turned-on turn signals and determining whether there is change in the recognized number of turned-on turn signals when the forward vehicle travels in the same lane as a lane of the ego vehicle.

Based on a turn signal of the forward vehicle being turned off, a turn signal of the forward vehicle in an opposite direction being turned on, an emergency light of the forward vehicle being turned on, there being no change in a lateral width of the forward vehicle, a pedestrian signal at a crosswalk in a direction of travel of the forward vehicle being turned on, or the forward vehicle stopping, the requirement for FCA warning generation suppression release may be determined to be satisfied.

In another aspect of the present disclosure, an autonomous vehicle includes at least one sensor provided at a front of the vehicle to detect visual data, a controller configured to control a Forward Collision-Avoidance Assist (FCA) warning of an ego vehicle based on the detected visual data, and an output unit configured to output the FCA warning to a driver based on a command from the controller, wherein the controller includes a detection module configured to detect a forward vehicle from the detected visual data, a driving situation determination module configured to determine a driving situation of the forward vehicle, an FCA warning determination module configured to determine whether a requirement for FCA warning generation and a requirement for FCA warning generation suppression are satisfied based on the driving situation of the forward vehicle, and an output module configured to output an FCA warning command when the requirement for FCA warning generation is satisfied.

The FCA warning determination module may be configured to determine whether there is change in a number of tires of the forward vehicle, whether a number of turned-on turn signals in the forward vehicle changes from one to two, and whether a lateral width of the forward vehicle increases, and determine that a requirement for FCA warning generation suppression of the vehicle is satisfied when there is change in the number of tires of the forward vehicle, the number of turned-on turn signals in the forward vehicle changes from one to two, or the lateral width of the forward vehicle increases, and not output the FCA warning command.

The output unit may generate an FCA warning using at least one of a visual, an auditory, or a tactile method.

Based on a turn signal of the forward vehicle being turned off, a turn signal of the forward vehicle in an opposite direction being turned on, an emergency light of the forward vehicle being turned on, there being no change in a lateral width of the forward vehicle, a pedestrian signal at a crosswalk in a direction of travel of the forward vehicle being turned on, or the forward vehicle stopping, the FCA warning determination module may determine that a requirement for FCA warning generation suppression release of the vehicle is satisfied, and output the FCA warning command.

In another aspect of the present disclosure, a program is recorded on a non-statutory computer-readable recording medium, wherein the method of controlling the FCA warning of the vehicle is executed by a processor.

In another aspect of the present disclosure, a computer-readable recording medium stores the program.

In another aspect of the present disclosure, a method of controlling a forward collision-avoidance assist (FCA) warning of an ego vehicle includes detecting movement of a forward vehicle by a sensor, determining the forward vehicle is at risk of collision with the ego vehicle based on the movement of the forward vehicle, and suppressing generation of the FCA warning based on the forward vehicle satisfying the requirement for FCA warning generation suppression.

The method may further include generating an FCA warning using at least one of a visual, an auditory, or a tactile method based on the forward vehicle satisfying a requirement for FCA warning generation suppression release.

Based on the forward vehicle stopping, the requirement for FCA warning generation suppression release is determined to be satisfied.

Based on a turn signal of the forward vehicle being turned off, the requirement for FCA warning generation suppression release is determined to be satisfied.

The forward vehicle may satisfy a requirement for FCA warning generation suppression based on: there being a change in a number of tires of the forward vehicle detected by the sensor; a number of active turn signals of the forward vehicle detected by the sensor changing from one to two; or a lateral width of the forward vehicle detected by the sensor increasing.

It is to be understood that both the foregoing general description and the following detailed description of the present disclosure are provided by way of example and are explanatory in nature. Accordingly, the foregoing general description and the following detailed description are intended to provide further explanation of the disclosure as claimed, without limiting the disclosure.

### BRIEF DESCRIPTION OF THE DRAWINGS

The accompanying drawings, which are included to enhance understanding of the disclosure and which are incorporated in and constitute a part of this application, illustrate embodiment(s) of the disclosure and together with the description serve to explain the principles of the disclosure. In the drawings:

FIG. 1 is a diagram illustrating a configuration of an autonomous vehicle according to an embodiment of the present disclosure;

FIG. 2 is a diagram illustrating a method of controlling a Forward Collision-Avoidance Assist (FCA) warning of a vehicle according to another embodiment of the present disclosure;

FIG. 3 illustrates a case where the FCA warning is unnecessary;

FIGS. 4-6 illustrate in detail specific examples in which the FCA warning is unnecessary; and

FIGS. 7-9 illustrate specific examples in which a requirement for FCA generation suppression release is satisfied.

### DETAILED DESCRIPTION OF THE DISCLOSURE

Hereinafter, some embodiments of the present disclosure are described in detail with reference to illustrative drawings. When adding reference numerals to components in each drawing, it should be noted that identical components are given the same reference numerals whenever possible even when the components are shown in different drawings. In addition, when describing embodiments of the present disclosure, when it has been determined that a specific description of a related known structure or function would hinder understanding of the embodiments of the present disclosure, a detailed description thereof has been omitted.

In the description of the embodiments according to the present disclosure, when an element is described as being formed “on or under” another element, the two elements may be directly in contact with each other or may be indirectly formed with one or more other elements disposed therebetween. In addition, when the expression “on or under” is used, a direction thereof may include a downward direction as well as an upward direction based on one element. When a component, unit, controller, device, element, apparatus or the like of the present disclosure is described as having a purpose or performing an operation, function, or the like, the component, unit, controller, device, element, or apparatus should be considered herein as being “configured to” meet that purpose or perform that operation or function. Each component, unit, controller, device, element, apparatus, and the like may separately embody or be included with a processor and a memory, such as a non-transitory computer readable media, as part of the apparatus.

In a method of controlling a Forward Collision-Avoidance Assist (FCA) warning of a vehicle, an autonomous vehicle, a program, and a computer-readable recording medium according to the present disclosure, an FCA warning may not be generated even when a forward vehicle is detected in front of an ego vehicle, if the forward vehicle is expected to soon depart from the front of the ego vehicle by changing lanes, etc.

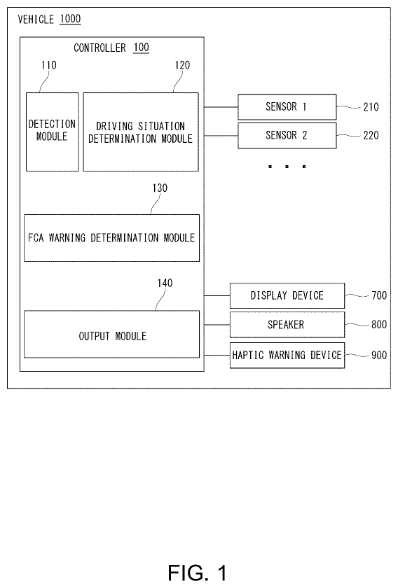

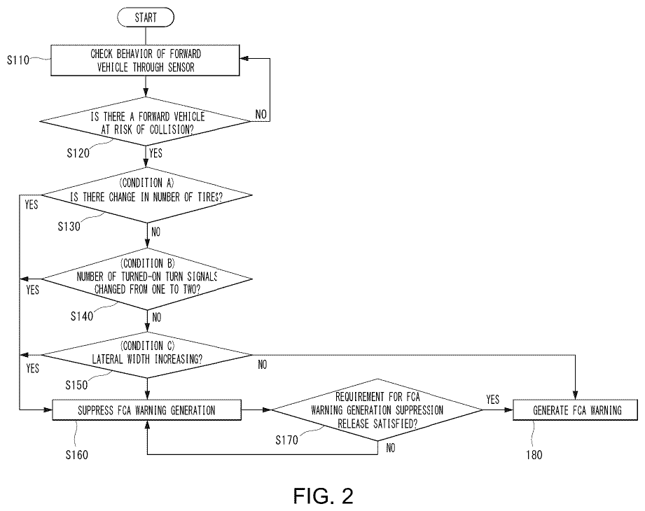

FIG. 1 is a diagram illustrating a configuration of an autonomous vehicle according to an embodiment of the present disclosure. FIG. 2 is a diagram illustrating a method of controlling an FCA warning of a vehicle according to another embodiment of the present disclosure. Hereinafter, a detailed description is given of an embodiment of a method of controlling an FCA warning of a vehicle and an autonomous vehicle according to the present disclosure with reference to FIGS. 1 and 2.

The method of controlling the FCA warning of the vehicle according to an embodiment of the present disclosure may include a step (S110) of checking a motion or behavior of a forward vehicle by a sensor, a step (S120) of checking if there is a forward vehicle at risk of collision with an ego vehicle from or based on the motion of the forward vehicle, a step (S130-S150) of determining whether the forward vehicle satisfies a requirement for FCA warning generation suppression, and a step (S160) of suppressing generation of an FCA warning when the forward vehicle satisfies the requirement for FCA warning generation suppression.

A vehicle 1000 may be an autonomous vehicle having a Smart Cruise Control (SCC) function and includes a plurality of sensors such as sensor 1 (e.g., a first sensor) 210 and sensor 2 (e.g., a second sensor) 220. The sensors 1 and 2 refer to devices installed at a front of a vehicle such as a front camera and a front radar, which detect visual data of a vehicle in motion to identify the vehicle in motion in front of a driving lane of an ego vehicle.

A controller 100 is provided in the vehicle to control an FCA warning of the ego vehicle from or based on the detected visual data. The controller may include a detection module 110 configured to detect a forward vehicle from detected visual data, a driving situation determination module 120 configured to determine a driving situation of the forward vehicle, an FCA warning determination module 130 configured to determine whether a requirement for FCA warning generation and a requirement for FCA warning generation suppression are satisfied from or based on the driving situation of the forward vehicle, and an output module 140 configured to output an FCA warning command when the requirement for FCA warning generation is satisfied (e.g., and a requirement for FCA warning generation is not satisfied).

In addition, an output unit that outputs an FCA warning to a driver according to the FCA warning command of the output module 140 of the controller 100 may be provided in the vehicle 1000. The output unit may include at least one of a display device 700, a speaker 800, or a haptic warning device 900.

It is verified whether a forward vehicle is present ahead or in front of the ego vehicle in a lane in which the ego vehicle is being driven by the sensors 1 and 2 (210 and 220), and when the presence of the forward vehicle is confirmed (Yes), it is verified whether there is a forward vehicle at risk of collision (S120).

The driving situation determination module 120 determines the driving situation of the forward vehicle, determines a possibility of collision between the ego vehicle and the forward vehicle, and determines whether to issue an FCA warning in the FCA warning determination module 130. A detailed description is as follows.

Even when there is a forward vehicle, if there is no risk of collision between the forward vehicle and the ego vehicle (No), for example, a distance from the ego vehicle is greater than or equal to a certain distance, a speed of the ego vehicle is excessively low (e.g., less than a predetermined threshold), or the ego vehicle is changing lanes, a determination as to whether the forward vehicle corresponds to or meets the requirement(s) for FCA warning generation suppression may not be performed. However, when or if there is a risk of collision between the forward vehicle and the ego vehicle (Yes), the determination as to whether the forward vehicle corresponds to or meets the requirement(s) for FCA warning generation suppression is performed.

In the FCA warning determination module 130, when a forward vehicle is detected to be changing lanes, it is possible to determine that an FCA warning does not need to be issued. Specifically, when one or more of three requirements below are met, it is possible to determine that the FCA warning generation is or should be suppressed (S160).

The three requirements are illustrated as S130-S150 in FIG. 1. However, the order of determination may be changed.

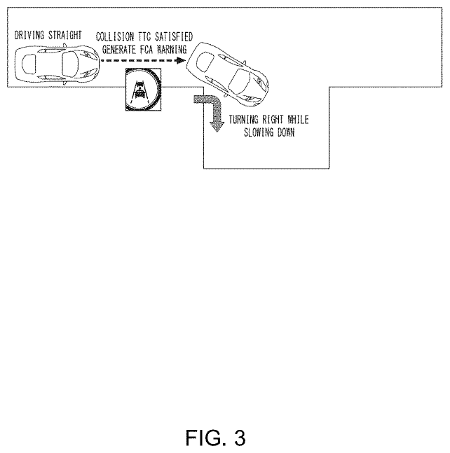

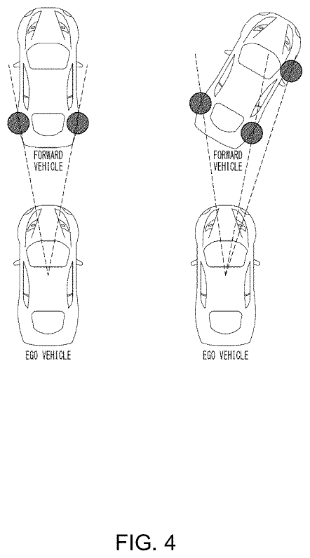

FIG. 3 illustrates a case in which the FCA warning is unnecessary, and FIGS. 4-6 illustrate in detail specific examples in which the FCA warning is unnecessary.

In FIG. 3, the ego vehicle is driving straight and there is a forward vehicle ahead or in front of the ego vehicle. However, the forward vehicle is slowing down and turning right, and thus the forward vehicle and the ego vehicle may not actually collide. In this instance, when the FCA warning is issued since a time to collision (TCC) requirement of the ego vehicle and the forward vehicle is satisfied, it will cause inconvenience to the driver and passenger(s), and the driver may unnecessarily apply the brakes.

First, condition (a) is determined. Specifically, a determination is made as to whether there is change in the number of tires of the forward vehicle detected by a sensor of the ego vehicle (S130). Referring to FIG. 4, as shown on the left, when the forward vehicle is driving straight ahead in the same lane as that of the ego vehicle, the number of tires of the forward vehicle detected by the sensor of the ego vehicle, for example, the front camera or the front radar, may be detected as two. In addition, as shown on the right, when the forward vehicle turns right ahead of the ego vehicle, the number of tires of the forward vehicle detected by the sensor of the ego vehicle may be detected as three or four.

Therefore, when there is change in the number of tires of the forward vehicle detected by the sensor of the ego vehicle (YES), a determination is made that the requirement for FCA warning suppression (S160) is satisfied, and thus the FCA warning may not be generated for the ego vehicle.

When there is no change in the number of tires of the forward vehicle detected by the sensor of the ego vehicle (No), condition (b) may be determined (S140).

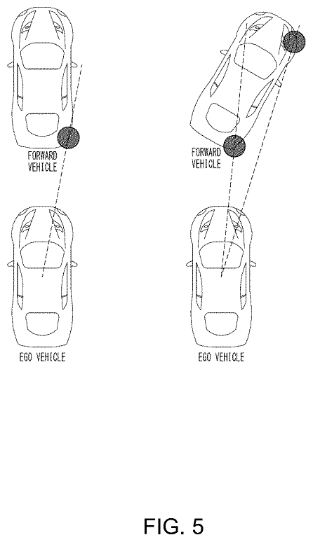

Specifically, a determination is made as to whether the number of turned-on or active turn signals of the forward vehicle detected by a sensor of the ego vehicle changes from 1 to 2 (S140). Referring to FIG. 5, as illustrated on the left, when the forward vehicle ahead in the same lane as that of the ego vehicle prepares to make a right turn, the number of turned-on turn signals of the forward vehicle detected by the sensor of the ego vehicle, for example, the front camera or the front radar may be detected as one. Then, as illustrated on the right, when the forward vehicle actually starts to make a right turn, the number of turned-on turn signals of the forward vehicle detected by the sensor of the ego vehicle may be detected as two. In addition, FIG. 5 illustrates a case where the forward vehicle makes a right turn, but step S140 may be equally applied even when the forward vehicle makes a left turn.

Therefore, when the number of turn signals of the forward vehicle detected by the sensor of the ego vehicle changes from one to two (YES), the requirement for the FCA warning generation suppression (S160) is determined to be satisfied, and thus the FCA warning may not be generated for the ego vehicle.

When the number of turn signals of the forward vehicle detected by the sensor of the ego vehicle does not change from one to two (NO), condition (c) may be determined (S140).

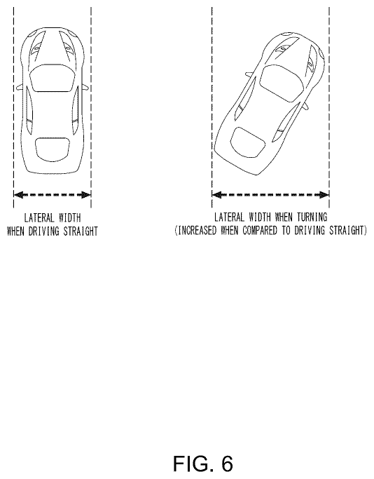

In detail, a determination is made as to whether a lateral width of the forward vehicle detected by the sensor of the ego vehicle is increasing (S150). Referring to FIG. 6, as illustrated on the left, when the forward vehicle prepares to make a right turn in front of the ego vehicle, the lateral width of the forward vehicle detected by the sensor of the ego vehicle, for example, the front camera or the front radar may be detected to be constant. Then, as illustrated on the right, when the forward vehicle starts to make a right turn, the lateral width of the forward vehicle detected by the sensor of the ego vehicle may increase. In addition, even though FIG. 6 illustrates a case where the forward vehicle makes a right turn, step S150 may be equally applied even when the forward vehicle makes a left turn.

Therefore, when the lateral width of the forward vehicle detected by the sensor of the ego vehicle increases (YES), the requirement for the FCA warning generation suppression (S160) is determined to be satisfied, and thus the FCA warning may not be generated for the ego vehicle.

Therefore, when the above-mentioned conditions (a)-(c) are satisfied, it is determined that there is no possibility of actual collision between the forward vehicle and the ego vehicle, and thus the FCA warning may not be generated. Therefore, the driver may avoid unnecessary braking without causing discomfort to the driver and the passenger(s).

Further, when none of the above-mentioned conditions (a)-(c) are satisfied, the FCA warning determination module 130 determines that there is a possibility of collision between the ego vehicle and the forward vehicle, and the output module 140 may generate an FCA warning command (S180).

Here, the FCA warning command may be output by at least one of the display device 700, the speaker 800, or the haptic warning device 900. For example, the display device 700 may visually output the FCA warning command by a navigation system or a cluster of the vehicle 1000, the FCA warning command may be audibly output by the speaker 800, or the FCA warning may be tactilely output by vibrating a driver's seat or seat belt by the haptic warning device 900.

When a requirement for FCA warning generation is satisfied while the ego vehicle is driven without generating the FCA warning since the above-mentioned requirement for FCA warning generation suppression is satisfied, the FCA warning needs to be issued.

Therefore, during FCA warning generation suppression (S160), the FCA warning determination module 130 continuously verifies whether the requirement for FCA warning generation suppression release is satisfied (S170). Then, when the requirement for FCA warning generation suppression release is satisfied (YES), an FCA warning is generated, and when the requirement for FCA warning generation release is not satisfied (NO), FCA warning generation suppression (S160) is continuously maintained.

The requirement for FCA warning generation suppression release is described in detail below.

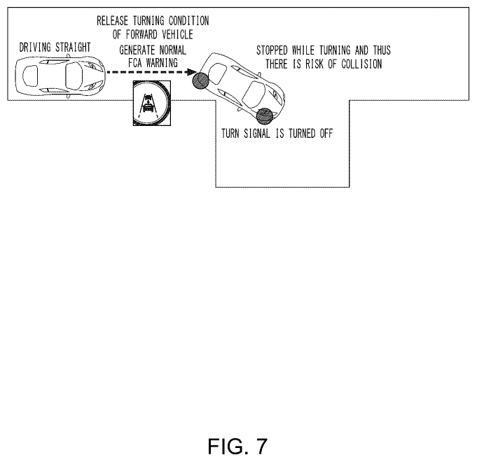

First, as shown in FIG. 7, when the turn signal of the forward vehicle is turned off, it is possible to determine that the forward vehicle has stopped changing lanes and there is a possibility of collision with the ego vehicle.

Second, the turn signal of the forward vehicle is turned on in an opposite direction. In this instance, for example, the forward vehicle may change lanes by turning right and then turning left, into the same lane as that of the ego vehicle, and thus it is possible to determine that there is a possibility of collision with the ego vehicle.

Third, an emergency light of the forward vehicle is turned on.

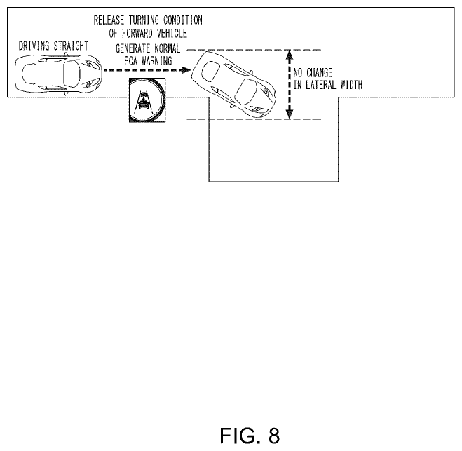

Fourth, as shown in FIG. 8, when a change rate of the lateral width of the forward vehicle is zero, the forward vehicle stops changing lanes at this time, and thus it is possible to determine that there is a possibility of collision with the ego vehicle.

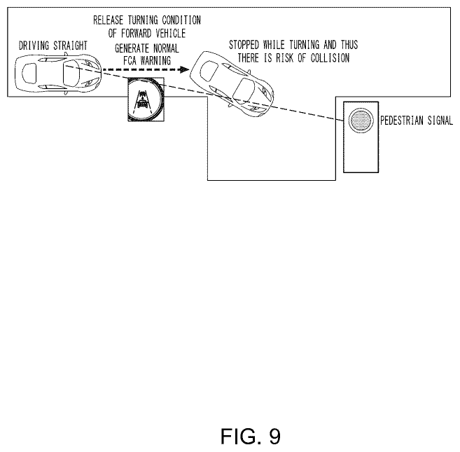

Fifth, as shown in FIG. 9, when a pedestrian signal at a crosswalk is turned on in a direction of travel of the forward vehicle, for example, when the forward vehicle is making a right turn and the pedestrian signal at the crosswalk on the right is turned on, the forward vehicle may stop and therefore it is possible to determine that there is a possibility of collision with the ego vehicle.

Sixth, when the forward vehicle stops, it is possible to determine that there is a possibility of collision with the ego vehicle.

Through the above-described step of determining whether the requirement for FCA warning generation suppression release is satisfied and step of generating the FCA warning, when a possibility of collision between the ego vehicle and the forward vehicle occurs or exists due to a change in the driving state of the forward vehicle during suppression of generation of the FCA warning, the FCA warning may be issued to the driver to prevent the possibility of collision between the ego vehicle and the forward vehicle.

According to a method of controlling an FCA warning of a vehicle, an autonomous vehicle, a program, and a non-transitory computer-readable recording medium according to the present disclosure, even when a forward vehicle is confirmed, if the requirement for FCA warning generation suppression is not satisfied, an FCA warning is not generated by determining that there is no possibility of collision between the forward vehicle and an ego vehicle. Therefore, it is possible to prevent discomfort to a driver or a passenger, and the driver may avoid unnecessary braking.

In addition, when a possibility of collision between the ego vehicle and the forward vehicle occurs or exists due to a change in the driving state of the forward vehicle, etc. during suppression of generation of the FCA warning, the possibility of collision between the ego vehicle and the forward vehicle may be prevented by issuing an FCA warning to the driver.

In the above description, even though all the components included in the embodiments of the present disclosure have been described as being combined into one or operating in combination, the present disclosure is not necessarily limited to these embodiments. Within the scope of the purpose of the present disclosure, all of the components may be selectively combined into one or more and operated. In addition, the terms “include”, “comprise”, or “have” described above, unless specifically stated to the contrary, mean that the corresponding components may be included, and therefore should be interpreted to include other components rather than excluding other components. All terms, including technical or scientific terms, unless defined otherwise, have the same meaning as commonly understood by a person of ordinary skill in the art to which the present disclosure pertains. Commonly used terms, such as terms defined in dictionaries, should be interpreted as consistent with meanings thereof in the context of the relevant art, and will not be interpreted in an idealized or overly formal sense, unless explicitly defined in the present disclosure.

The above description is only an illustrative example of the technical idea of the present disclosure, and those of ordinary skill in the art to which the present disclosure pertains may make various modifications and variations without departing from the essential characteristics of the present disclosure. Accordingly, the embodiments published in the present disclosure are not intended to limit the technical idea of the present disclosure but to describe the technical idea, and the scope of the technical idea of the present disclosure is not limited by these embodiments. The scope of protection of the present disclosure should be interpreted by the claims below, and all technical ideas within a scope equivalent thereto should be interpreted as being included in the scope of rights of the present disclosure.

What is claimed is:

1. A method of controlling a forward collision-avoidance assist (FCA) warning of an ego vehicle, the method comprising:
checking a motion of a forward vehicle by a sensor;
determining the forward vehicle is at risk of collision with the ego vehicle based on the motion of the forward vehicle;
determining whether the forward vehicle satisfies a requirement for FCA warning generation suppression; and
suppressing generation of the FCA warning based on the forward vehicle satisfying the requirement for FCA warning generation suppression.

2. The method according to claim 1, wherein, based on the forward vehicle not satisfying the requirement for FCA warning generation suppression, the FCA warning is generated using at least one of a visual, an auditory, or a tactile method.

3. The method according to claim 1, further comprising determining whether the forward vehicle satisfies a requirement for FCA warning generation suppression release,
wherein the FCA warning is generated using at least one of a visual, an auditory, or a tactile method when the forward vehicle satisfies the requirement for FCA warning generation suppression release.

4. The method according to claim 3, wherein, based on the forward vehicle not satisfying the requirement for FCA warning generation suppression release, the suppressing generation of the FCA warning continues.

5. The method according to claim 1, wherein the determining whether the forward vehicle satisfies a requirement for FCA warning generation suppression comprises:
a step (a) of determining whether there is change in a number of tires of the forward vehicle detected by the sensor;
a step (b) of determining whether a number of turned-on turn signals in the forward vehicle changes from one to two; and
a step (c) of determining whether a lateral width of the forward vehicle increases,
wherein, when at least one of the steps (a)-(c) is determined to be YES, the forward vehicle is determined to satisfy the requirement for FCA warning generation suppression.

6. The method according to claim 5, wherein, based on all the steps (a)-(c) being determined to be NO, the FCA warning is generated using at least one of a visual, an auditory, or a tactile method.

7. The method according to claim 5, wherein the step (a) comprises recognizing the number of tires and determining whether there is change in the recognized number of tires when the forward vehicle travels in the same lane as a lane of the ego vehicle.

8. The method according to claim 5, wherein the step (b) comprises recognizing the number of turned-on turn signals and determining whether there is change in the recognized number of turned-on turn signals when the forward vehicle travels in the same lane as a lane of the ego vehicle.

9. The method according to claim 3, wherein, based on a turn signal of the forward vehicle being turned off, a turn signal of the forward vehicle in an opposite direction being turned on, an emergency light of the forward vehicle being turned on, there being no change in a lateral width of the forward vehicle, a pedestrian signal at a crosswalk in a direction of travel of the forward vehicle being turned on, or the forward vehicle stopping, the requirement for FCA warning generation suppression release is determined to be satisfied.

10. An autonomous vehicle comprising:
at least one sensor provided at a front of the vehicle to detect visual data;
a controller configured to control a Forward Collision Avoidance Assist (FCA) warning of an ego vehicle based on the detected visual data; and
an output unit configured to output the FCA warning to a driver based on a command from the controller,
wherein the controller comprises:
a detection module configured to detect a forward vehicle from the detected visual data;
a driving situation determination module configured to determine a driving situation of the forward vehicle;
an FCA warning determination module configured to determine whether a requirement for FCA warning generation and a requirement for FCA warning generation suppression are satisfied based on the driving situation of the forward vehicle; and
an output module configured to output an FCA warning command when the requirement for FCA warning generation is satisfied.

11. The autonomous vehicle according to claim 10, wherein the FCA warning determination module is configured to:
determine whether there is change in a number of tires of the forward vehicle, whether a number of turned-on turn signals in the forward vehicle changes from one to two, and whether a lateral width of the forward vehicle increases, and
determine that a requirement for FCA warning generation suppression of the vehicle is satisfied when there is change in the number of tires of the forward vehicle, the number of turned-on turn signals in the forward vehicle changes from one to two, or the lateral width of the forward vehicle increases, and not output the FCA warning command.

12. The autonomous vehicle according to claim 10, wherein the output unit generates an FCA warning using at least one of a visual, an auditory, or a tactile method.

13. The autonomous vehicle according to claim 10, wherein, based on a turn signal of the forward vehicle being turned off, a turn signal of the forward vehicle in an opposite direction being turned on, an emergency light of the forward vehicle being turned on, there being no change in a lateral width of the forward vehicle, a pedestrian signal at a crosswalk in a direction of travel of the forward vehicle being turned on, or the forward vehicle stopping, the FCA warning determination module determines that a requirement for FCA warning generation suppression release of the vehicle is satisfied, and outputs the FCA warning command.

14. A program recorded on a non-transitory computer-readable recording medium, wherein the method of controlling the FCA warning of the vehicle according to claim 1 is executed by a processor.

15. A computer-readable recording medium storing the program according to claim 14.

16. A method of controlling a forward collision-avoidance assist (FCA) warning of an ego vehicle, the method comprising:
detecting movement of a forward vehicle by a sensor;
determining the forward vehicle is at risk of collision with the ego vehicle based on the movement of the forward vehicle;
suppressing generation of the FCA warning based on the forward vehicle satisfying the requirement for FCA warning generation suppression.

17. The method of claim 16, further comprising:
generating an FCA warning using at least one of a visual, an auditory, or a tactile method based on the forward vehicle satisfying a requirement for FCA warning generation suppression release.

18. The method of claim 17, wherein based on the forward vehicle stopping, the requirement for FCA warning generation suppression release is determined to be satisfied.

19. The method of claim 17, wherein based on a turn signal of the forward vehicle being turned off, the requirement for FCA warning generation suppression release is determined to be satisfied.

20. The method of claim 16, wherein the forward vehicle satisfies a requirement for FCA warning generation suppression based on:
there being a change in a number of tires of the forward vehicle detected by the sensor;
a number of active turn signals of the forward vehicle detected by the sensor changing from one to two; or
a lateral width of the forward vehicle detected by the sensor increasing.
